(19) United States
(12) Patent Application Publication
(10) Pub. No.: US 2011/0083396 A1
(43) Pub. Date: Apr. 14, 2011

(54) STUCCO FASTENER

(75) Inventors: Lawrence S. Shelton, Morton Grove, IL (US); Donald E. Bergstrom, Lindenhurst, IL (US); Tunjen Chu, Plainfield, IL (US)

(73) Assignee: ILLINOIS TOOL WORKS INC., Glenview, IL (US)

(21) Appl. No.: 12/895,224

(22) Filed: Sep. 30, 2010

Related U.S. Application Data
(60) Provisional application No. 61/250,167, filed on Oct. 9, 2009.

(51) Int. Cl. E04B 1/38; F16B 15/00; F16B 15/02

(52) U.S. Cl. 52/698; 411/439; 411/500

(57) ABSTRACT

A fastener is configured for securing a lath to a surface for, for example, the application of stucco to the surface. The fastener includes a fastener having a head, a shank and a penetrating tip. The head has a diameter and the shank has a diameter less than the head diameter. The stucco fastener has a sealing/spacer assembly having spacer element and a sealing element. The spacer element is formed from a relatively incompressible material and has a diameter greater than the shank diameter. The spacer element has a bore therein having a diameter about equal to the shank diameter. The sealing element is formed from a resilient, water-resistant material and is positioned adjacent to and in contact with the spacer element. When the fastener is driven into the surface, the fastener penetrates the surface to secure the fastener to the surface and a portion of the lath is captured between the head of the fastener and the spacer element to space the lath from the surface. The sealing element contacts the surface to form a seal at the fastener penetration to prevent the incursion of liquid into the surface around the fastener penetration, and the sealing element, as least in part, conforms to the surface between the surface and the spacer element.

### CROSS-REFERENCE TO RELATED APPLICATION DATA

This application claims the benefit of priority of Provisional U.S. Patent Application Ser. No. 61/250,167, filed Oct. 9, 2009.

### BACKGROUND OF THE INVENTION

This invention pertains to fasteners. More particularly, the invention pertains to a nail for use for applying a stucco finish to a substrate.

In applying a stucco finish to a surface, such as a wall, a lath is fastened to the surface spaced from the surface. Stucco is a liquid-like material that is applied in a water-borne slurry. The slurry hardens as it dries.

The lath can be, for example, a wire frame that allows the stucco material to flow through the frame and around the wires. As the stucco dries, it hardens around the wire and between the wire and the surface behind the lath.

Typically, the material onto which the stucco is applied is wood, more specifically, an oriented strand board (OSB), plywood, or like planar material. Wood boards may also be used.

It is desirable to prevent liquid from penetrating, and moisture incursion, into the underlying (wood or wood-based) material. In order to prevent liquid infiltration, a layer of liquid impermeable material or membrane is applied to the underlying material. However, nails are used to install the wire lath, which results in nail holes in the liquid impermeable membrane. As such, the nail holes provide a path for liquid to pass through the membrane and infiltrate the underlying material. It will be appreciated that moisture infiltration can result in damp regions of the structure, mold and mildew growth, general degradation of the structure and other undesirable conditions occurring.

Numerous devices and nails are known for fastening lath to surfaces. One device is a complex arrangement that includes a large collar-like member, through which a nail is inserted, that is filled with a viscous sealant material. As the nail is driven into the underlying material, the collar serves to space the lath from the surface, and a plunger inside the collar forces the sealant out of the bottom of the collar, between the collar and surface, to seal around the nail hole. While this product functions well, it is a relatively complex and costly arrangement, with numerous separate parts, some of which are moving and some of which are molded. Moreover, driving this fastener into the structure, against the membrane, can result in damage to the membrane. This arrangement also requires that the sealant material be properly ejected from the collar to seal the nail hole and at times the sealant does not cover the sealing area.

Another attempt to provide the space and sealing required is referred to as a wad nail or furring nail with wad. In this arrangement, a furring nail with a large or relatively thick cardboard-like material (wad) is driven into the underlying material. The wire is captured between the nail head and the wad to secure the wire in place. While this functions well to secure the wire and space the wire from the underlying material, it provides an easy path for moisture infiltration underneath the wad, through the membrane, and into the structure.

Other fasteners that are used to fasten the lath include staples. However, like the wad nail, staples result in forming holes in the membrane that provide an easy infiltration path. One solution to the infiltration problem caused with the wad nails and staples is to caulk or seal each individual nail (staple) hole with a sealing compound. While this may be effective in reducing or eliminating the infiltration problem, it is extremely labor intensive and costly, and given the number of fasteners used in a typical residential stucco installation, generally about 10,000 nails per home, there is a high probability that one or more of the nail or staple holes will be missed or not properly caulked. In addition, that caulk, which can sometimes be over-applied, reduces the amount of stucco that is used, which can be detrimental to the stucco finish. It has also been found that cracks can form in the stucco surface due to age, settling, vibrations and other conditions.

Accordingly, there is a need for a self-sealing nail. Such a nail can be a furring nail for use in stucco installation. Desirably, such a nail does not use a liquid or semi-liquid sealant material. More desirably, such a furring nail does not require the use of a sealant. More desirably still, such a furring nail is provided as an assembly, is easy to use, requires no additional labor to install and is low in cost.

### BRIEF SUMMARY OF THE INVENTION

A fastener for securing a lath to a surface for, for example, the application of stucco to the surface, wherein the fastener self-seals at the penetration of the surface to prevent the incursion of moisture and liquids into the surface.

The fastener includes a fastener having a head, a shank and a penetrating tip. The head has a diameter and the shank has a diameter less than the head diameter.

A sealing/spacer assembly has a spacer element and a sealing element. The spacer element is formed from a relatively incompressible material. The spacer element has a diameter greater than the shank diameter and can be greater than the head diameter. The spacer element has a bore therein having a diameter about equal to the shank diameter. The sealing element is formed from a resilient, compressible, water-resistant material and is positioned below and in contact with the spacer element.

When the fastener is driven into the surface, the fastener penetrates the surface to secure the stucco fastener to the surface and a portion of the lath is captured between the head of the fastener and the spacer element to space the lath from the surface. The sealing element contacts the surface to form a seal at the fastener penetration to prevent the incursion of liquid into the surface around the fastener penetration. The sealing element, at least in part, conforms to the surface between the surface and the spacer element.

The fastener can be a nail or alternatively a threaded fastener such as a screw. The sealing element can be adhered to the spacer element.

The spacer element can be formed from a fibrous material, such as paper, paperboard or paperboard-based material. Optionally, the fibrous spacer element can be treated with a water repellant material. Alternatively, the spacer element can be formed from a polymeric material such as polypropylene.

The sealing element is formed from a resilient, conformable, compressible, polymeric material. A preferred sealing element is formed from a material having a Shore A durometer of about 35 to about 65 and preferably about 50 to about 55. One suitable material is a thermoplastic compound of ethylene-propylene-diene monomer (EPDM) copolymer and polypropylene (PP).

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying illustrations and drawings, wherein:

FIG. 1 is side view illustration of a section of wall showing a pair of fasteners embodying the principles of the stucco fastener securing a wire mesh to the wall;

FIG. 2A is a sectional view of an embodiment of the stucco fastener, shown with a portion of a nail positioned in the spacer;

FIG. 2B is a top view of the fastener with the nail removed for clarity of illustration;

FIG. 3 is cross-sectional view of an exemplary spline nail for use with the spacer and washer to form the stucco nail;

FIGS. 4A and 4B are sectional and top views of an alternate embodiment of the stucco fastener, shown with the nail removed for clarity of illustration;

FIGS. 5A and 5B are sectional and top views of another alternate embodiment of the stucco fastener, shown with the nail removed for clarity of illustration;

FIGS. 6A and 6B are sectional and top views of still another alternate embodiment of the stucco fastener, shown with the nail removed for clarity of illustration;

FIG. 7 is a sectional view of yet another alternate embodiment of the stucco fastener, shown with the nail removed for clarity of illustration;

FIGS. 8A and 8B are sectional and bottom views of another alternate embodiment of the stucco fastener, shown with the nail removed for clarity of illustration;

FIG. 9 is an illustration of a nail driven into a surface in a non-normal orientation (askew) and the conforming nature of the sealing/spacer assembly; and

FIG. 10 is a sectional illustration of yet another alternate embodiment having a unitary spacer/sealing assembly.

### DETAILED DESCRIPTION OF THE INVENTION

While the present invention is susceptible of embodiment in various forms, there is shown in the drawings and will hereinafter be described several preferred embodiments with the understanding that the present disclosure is to be considered an exemplification of the invention and is not intended to limit the invention to the specific embodiments illustrated.

It should be further understood that the title of this section of the specification, namely, “Detailed Description of the Invention,” relates to a requirement of the United States Patent Office, and does not imply, nor should be inferred to limit the subject matter disclosed herein.

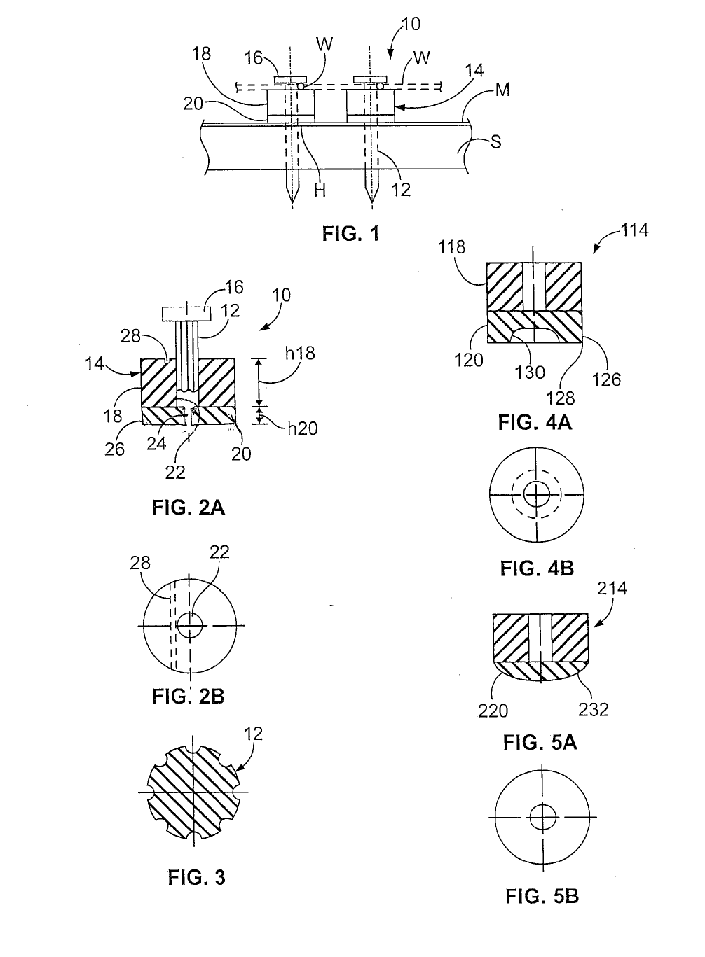

Referring now to the figures and in particular to FIG. 1, there is shown a stucco fastener 10 embodying the principles of the present invention. The fastener 10 includes a nail 12 and a sealing/spacer assembly 14. As illustrated, the fastener 10 is driven into an underlying structure S, such as a wall that has a moisture impervious membrane M, for example, a VALERON® house-wrap film or an asphalt-faced paper, to prevent moisture infiltration into the wall structure S. The wall structure S can be, for example, plywood, OSB or another rigid, structural element.

A wire mesh W or the like is secured to the wall by capture between the head 16 of the nail 12 and the spacer portion 18 of the sealing/spacer assembly 14. In this manner, the wire mesh W is secured to the structure S so that the stucco material (not shown for clarity of illustration) can be applied to the structure S. It will be appreciated that the stucco material will be “worked” into the space behind and around the mesh W, and over the mesh W and the fastener assemblies 10 to produce a finished stucco finish.

As set forth above, the stucco is applied as a slurry having an aqueous or other liquid carrier. As the stucco dries, that is as the liquid evaporates, it hardens around the wire mesh W and fasteners 10 and between the wire W and the membrane M/wall S. The hardened stucco provides a weather-proof finish for the structure. However, in that the stucco is applied in a slurry form, the nail holes H can provide a path for infiltration of water or other liquids into the structure S.

The stucco fastener 10 eliminates the infiltration path for liquids by providing a seal at the nail hole H. Referring to FIG. 2, the stucco fastener 10 includes the nail 16 and the sealing/spacer assembly 14. The sealing/spacer assembly 14 is formed as a two-piece member having the rigid spacer element 18 and a resilient sealing element 20. In the assembly 14, the spacer element 18 can be formed from a water impervious, non-degrading material, such as a polymer (plastic) such as polypropylene (PP) and the like. Other polymeric materials can be used, such as polyethylene terephthalate (PET) and the like. Other suitable materials will be appreciated by those skilled in the art. The spacer element 18 and sealing element 20 can be formed individually and subsequently assembled into the assembly 14. It will also be appreciated that if the spacer 18 and sealing element 20 are moldable polymeric materials, if compatible, the assembly 14 can be formed as a co-molded part, by, for example, over-molding, insert molding or the like.

The spacer element 18 is of a relatively incompressible or mildly incompressible design so that it provides a structural base on which the mesh W can be affixed and on which the stucco can be applied.

The sealing element 20 is formed from a softer or more resilient material. The sealing element 20 provides protection from infiltration of water or other liquid carrier for the slurry, and to prevent moisture infiltration when, for example, the wall is exposed to the environs prior to application of the stucco. The sealing element 20 also provides long term protection for the structure from water that may be present behind the stucco finish. In one embodiment, the sealing element 20 is formed from SANTOPRENE® which is a mixture of in-situ cross linking of ethylene-propylene-diene monomer copolymer (EPDM) rubber. This thermoplastic compound is processed in much the same way as any type of plastic, but possesses about the same levels of flexibility and durability that are commonly found with natural rubber compounds. This is a preferred material because of its exhibited longer life in both extreme hot and cold environments. Other suitable materials, such as SARLINK® can be used and will be recognized by those skilled in the art.

It will be appreciated that the spacer 18 is preferably a somewhat compressible or conformable material so that the spacer 18 and sealing 20 elements (the sealing/spacer assembly 14) conform to inconsistencies in the surface S, including being driven into the surface S in a non-normal orientation (being driven at an angle that is not straight or is askew to the surface, see, e.g., FIG. 9). It will be understood that the spacer 18 is intended to provide a base for capturing the wire mesh W—a support against which the wire mesh W is held—while at the same time providing a sufficient body to ensure that the sealing element 20 is urged into intimate contact with the surface S to form a seal.

A presently used grade of SANTOPRENE has a Shore A durometer of about 55, making it about as hard or as pliable as a door seal. It has been found that this material provides good sealing characteristics in the temperature range that structures in all environments are typically subjected to. It is contemplated that materials have a Shore A durometer of about 35 to 65 and preferably about 50 to 55 will be suitable. Again, other suitable materials, having such characteristics will be recognized by those skilled in the art. For example, it is anticipated that materials such as styrene butadiene (SBR), nitrile rubber, natural rubber (NR), polyurethanes, silicones and the like will exhibit good weather and water resistance, resilience, conformability and compressibility characteristics to serve as the sealing element.

Accordingly, in the present disclosure when, for example the spacer element 18 is referred to as relatively incompressible, that it is relative to the sealing element 20, which is compressible, and is not to be understood to be an absolute characteristic of the material. The nature of the fastener 10 is such that the sealing element 20 is intended to conform to the surface S, at least in part by compressing against the surface S, and that the spacer 18 is configured to urge the sealing element 20 into intimate contact with the surface S. Thus, there will be some measure of compressibility of the spacer element 18, as seen in FIG. 9.

In a fastener 10 consistent with the present invention, the spacer element 18 is formed having a pre-formed opening 22 for receiving the nail 12. The opening 22 is configured (sized) to provide a snug fit of the nail 12, so that the fastener 10 can be supplied with the nail 12 pre-installed in the sealer/spacing assembly 14 for ease of installation. The sealing element 20 can be formed with a pre-formed opening 24, a weakened central area or as a solid, uninterrupted element. The sealing element 20 can also be formed so that a plug is ejected from the element as the nail is driven therethrough. In a preferred embodiment, the sealing element is formed with an opening 24 that is smaller in diameter than the diameter of the nail 12 (see, e.g., FIG. 2A). The sealing element can be formed about the same diameter as the spacer element or the sealing element can be formed having a smaller or larger diameter than the spacer element.

In an illustrative embodiment, the stucco fastener 10 is configured to accommodate a nail 12 having a shank diameter of about 0.120 inches, a head diameter of about 0.375 inches and a length of about 1.75 inches. For such a nail 12, the spacer element 18 has a diameter of about 0.60 inches with an opening 22 for the nail 12 of about 0.121 inches and a thickness or height h₁₈ of about 0.25 inches. The sealing element 20 has a diameter equal to that of the spacer element 18, a thickness (or height h₂₀) of about 0.125 inches and optionally can be formed having a rounded (or radiused) lower edge 26 (about a 1/16^{th} inch radius) to prevent the membrane M from being damaged when the nail 12 is driven into the surface S (which can create moisture problems). It is anticipated that the sealer/spacing assembly 14 can be formed in a coextrusion process or can be an assembled member with the sealing element 20 adhered to the spacer element 18. Optionally still, the spacer element 18 can be formed with grooves or channels 28 to accommodate a portion of the wire mesh W.

In the fastener illustrated in FIG. 2, the nail 12 is a splined or grooved nail which provides excellent structural characteristics and holding power (resistance to pull-out) while reducing material requirements. A cross-sectional view of the splined nail is shown in FIG. 3. Such a nail is more fully described in Shelton, U.S. Patent application publication No. 2008-0193257, entitled “Grooved Fastener”. It will be appreciated that the splined nail 12 or any other type of nail 12, for example, a ring shank nail, can be used in the stucco fastener 10.

An alternate embodiment of the sealing/spacing assembly 114 is shown in FIGS. 4A and B. In this embodiment, the sealing element 120 is formed having an inverted cup shape formed by a lip 126 extending downwardly from about the periphery 128 of the sealing element 120. The lip 126 encircles the area in which the nail (not shown) penetrates the membrane M and underlying structure S to provide the seal. In an illustrative embodiment, the sealing element 120 has an overall thickness (height) of about 0.125 inches. The depending lip 126 has a thickness (height) of about 0.045 inches, and an inside radius of curvature (at 130) of about 0.045 inches.

Still another alternate embodiment 214 is illustrated in FIGS. 5A and 5B. This embodiment is similar to that of FIGS. 2A and 2B, except that the bottom surface 232 of the sealing element 220 (the surface 232 that contacts the membrane M) is formed having an overall curved surface. The sealing element 220 has a thickness (height) of about 0.125 inches and a radius of curvature of about 0.375 inches. The overall curved surface 232 maintains good sealing even if the nail is not driven straight (normal to the surface, see, for example, FIG. 9).

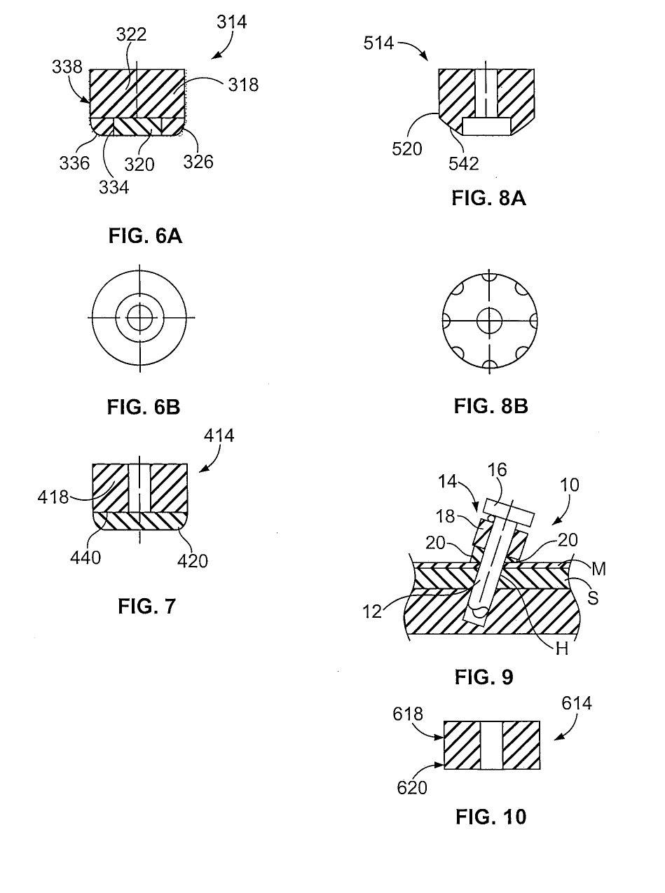

Still another alternate embodiment 314 is illustrated in FIGS. 6A and 6B. In this embodiment, the spacer portion 318 is formed having a well 334 in the bottom surface 336 in addition to the through bore 322 (for the nail). The well 334 is about 0.343 inches in diameter and about 0.062 inches deep. The bottom outer corners 326 can be formed having a curved edge, with a radius of curvature of about 0.032 inches.

The sealing element 320 is fitted into the well. The sealing element 320 has a thickness (height) of about 0.156 inches and a diameter of 0.343 inches (to match the diameter of the well). The spacer portion 318 can be formed having a roughened outer surface (as at 338).

Yet another alternate embodiment of the sealing/spacer assembly 414 is illustrated in FIG. 7. This embodiment 414 is similar in size and configuration to that of the embodiment 114 in FIGS. 2A and B. The sealing element 420 can be formed from the above-noted EPDM-PP (e.g., SANTOPRENE®), or like material, but the spacer element 418 is formed from a different material. In such an alternate embodiment 414, the spacer element 418 is formed from a fibrous material such as paperboard or a paperboard based material (cardboard, recycled paper and paperboard products and the like), forming a base material. The base material 418, as shown, can be compressed to increase the density and structural strength (e.g., reduce the compressibility) of the material. Compression (or densification) also increases the ability of the material 418 to repel water or other liquids. If desired, the sealing element 420 may be adhered to the spacer element by 418, for example, an adhesive 440.

Optionally, the base material 418 (the densified board product) can be treated with any of a wide variety of water-resistant or water-repellant materials, such as resins, epoxies, bituminous materials and the like. The treatment can be a coating and/or impregnation of the spacer element 418 to form a water-resistant element.

It will be appreciated that the untreated spacer element in conjunction with the sealing element will function well to seal the area around the fastener (nail) hole to prevent the infiltration of water for the time that the stucco fastener left exposed to the environs and during the stucco application and drying process. As such, the treatment is not necessary, but is anticipated to be advantageous if used.

It is anticipated that coating and/or impregnating the spacer element 418 base material will substantially increase the ability to repel or resist degradation due to water or other liquids and to retain the necessary structural characteristics. A preferred water-resistant material is polyurethane phenolic wax, however, as set forth above, other suitable materials are contemplated.

It will be appreciated that the water resistant nature of the treated base material 418, along with the polymeric sealing element 420 will provide the necessary sealing for the nail opening (in the membrane M) without post-treating, such as caulking and the like.

Still another embodiment of the sealing/spacer assembly 514 is illustrated in FIGS. 8A and 8B. In this embodiment, the sealing element 520 is formed having a plurality of depending legs or protrusions 542. As the fastener 510 is driven into the wall, the legs 542 flatten to form a continuous ring or sealing region.

Another embodiment of the sealing/spacer assembly 614 is illustrated in FIG. 10, in which the assembly (i.e., the spacer element/function 618 and the sealing element/function 620) are formed as a unitary assembly. It will be appreciated that such an assembly 614 can be cut from a bulk material, formed as a molded, extruded or like component. Such an element 614 can be molded or formed (e.g., coextruded or co-molded) from different materials or from a single material that is sealed (by nature of the material if it exhibits the desired sealing characteristics), or by coating, impregnating the material, vulcanization or the like.

It will be appreciated that the stucco fastener 10-610 provides a number of advantages over known fasteners used to fasten stucco wire mesh to a surface. First, the stucco fastener provides a low-cost, simplified structure member to secure the wire mesh to the structure. Moreover, the fastener self-seals to the structure without the need for any post-installation process, such as caulking or the like. The self-sealing feature saves significant time in labor and expense in additional materials. In addition, many installers require follow-up inspections when caulk is required, which inspections are also eliminated when using the stucco fastener.

It will also be appreciated that minor imperfections or inconsistencies in, for example, a wall surface S, can be accommodated by the resilient, conforming nature of the sealing element 20-620. Moreover, the relatively soft nature of the sealing element will reduce the opportunity for the stucco fastener 10-610 to pierce or tear the membrane M applied to the underlying substrate S (other than the hole formed by the nail) as a result of the sealing/spacer assembly contacting the membrane M. It will be understood that reducing the chance of damaging the membrane M reduces the opportunity for water/liquid infiltration and moisture incursion, and the resulting conditions that can occur.

It will be further appreciated that the “forgiving” nature of the stucco fastener 10-610 make it suitable for many other, e.g., non-stucco, related applications that require the piercing or penetrating of a membrane M in securing a fastener to a structure S and that such uses are within the scope and spirit of the present invention. The forgiving nature of the fastener 10-610 may also help to reduce cracking in the stucco as a result of aging, growth and shrinkage, for example due to changing weather conditions/temperature fluctuations and the like by accommodating shifting of the finish, dimensional changes and vibrational forces.

The forgiving nature of the assembly 10-610 also make it suitable for use in applications for attachment to structures S that may be subjected to vibration or seismic events in which movement of a structure relative to, for example, a secured finish on the structure can be accommodated. That is, the fastener 10-610 provides some measure of flexibility that can be advantageous over a purely rigid fastening member.

It will also be appreciated that although the present disclosure describes the sealing/spacer assembly being used with a nail, screws, staples or other fasteners may be used and that a fastener using screws, staples and such other fasteners are within the scope and spirit of the present invention. It is contemplated that if nails are used, such nails will be of the type having a shank deformation, such as ring shank nails. Nails can be formed, for example, as disclosed in Binder, U.S. Pat. No. 5,476,351, commonly assignee with the present application and incorporated herein by reference. Such nails can be formed with heads having a plurality of ribs or ridges that extend across the head of the nail, or alternately, such ribs or ridges can be formed in a concentric pattern to provide more assured contact between the fastener and the tool used to drive the fastener.

All patents referred to herein, are hereby incorporated herein by reference, whether or not specifically done so within the text of this disclosure.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A stucco fastener for securing a lath to a surface for the application of stucco to the surface, the stucco fastener comprising:
a fastener having a head, a shank and a penetrating tip, the head having a diameter and the shank having a diameter less than the head diameter, the fastener having length;
a sealing/spacer assembly having a spacer element and a sealing element, the spacer element formed from a relatively incompressible material, the spacer element having a diameter greater than the shank diameter, the spacer element having a bore therein having a diameter about equal to the shank diameter, the sealing element being formed from a resilient, water-resistant material and being positioned adjacent to and in contact with the spacer element,
wherein when the fastener is driven into the surface, the fastener penetrates the surface to secure the stucco fastener to the surface, and wherein a portion of the lath is captured between the head of the fastener and the spacer element to space the lath from the surface and the sealing element contacts the surface to form a seal at the fastener penetration to prevent the incursion of liquid into the surface around the fastener penetration, and wherein the sealing element, as least in part, conforms to the surface between the surface and the spacer element.

2. The stucco fastener in accordance with claim 1 wherein the fastener is a nail.

3. The stucco fastener in accordance with claim 1 wherein sealing element is adhered to the spacer element.

4. The stucco fastener in accordance with claim 1 wherein the spacer element is formed from a fibrous material.

5. The stucco fastener in accordance with claim 4 wherein the fibrous is a paper-based material.

6. The stucco fastener in accordance with claim 1 wherein the spacer element is treated with a water repellant material.

7. The stucco fastener in accordance with claim 1 wherein the sealing element is formed from a polymeric material.

8. The stucco fastener in accordance with claim 7 wherein the polymeric material has a Shore A durometer of about 55.

9. The stucco fastener in accordance with claim 7 wherein the polymeric material is a thermoplastic compound of ethylene-propylene-diene monomer (EPDM) copolymer and polypropylene (PP).

10. The stucco fastener in accordance with claim 1 wherein the spacer element is formed from a relatively rigid polymeric material.

11. The stucco fastener in accordance with claim 1 wherein the spacer element and the sealing element are formed from different materials.

12. The stucco fastener in accordance with claim 1 wherein the spacer element and the sealing element are formed from the same material.

13. The stucco fastener in accordance with claim 1 wherein the spacer element and the sealing element are formed as a unitary assembly.

14. The stucco fastener in accordance with claim 1 wherein the spacer element and the sealing element have about equal diameters.

15. The stucco fastener in accordance with claim 1 wherein the sealing element has a diameter greater than the diameter of the spacer element.

16. The stucco fastener in accordance with claim 1 including an opening in the sealing/spacer assembly.

17. The stucco fastener in accordance with claim 2 wherein the nail is a ring shank nail.

18. A fastener for securing a lath to a surface for the application of a finish material to the surface, the fastener comprising:
a fastener having a head, a shank and a penetrating tip, the shank having a diameter, the fastener having length;
a sealing/spacer assembly formed from a conformable material, the material being resilient and water-resistant,
wherein when the fastener is driven into the surface, the fastener penetrates the surface to secure the fastener to the surface, and wherein a portion of the lath is captured between the head of the fastener and the sealing/spacer assembly to space the lath from the surface and the sealing/spacer assembly contacts the surface to form a seal at the fastener penetration to prevent the incursion of liquid into the surface around the fastener penetration, and wherein the sealing/spacer assembly, at least in part, conforms to the surface between the surface and the sealing/spacer assembly.

19. The fastener in accordance with claim wherein the sealing/spacer assembly is formed as a unitary member from more than one material.

20. The fastener in accordance with claim 18 wherein the sealing/spacer assembly is treated to from a liquid impervious sealing/spacer assembly.
